(19) United States
(12) Patent Application Publication
(10) Pub. No.: US 2008/0138534 A1
(43) Pub. Date: Jun. 12, 2008

(54) Method For Plasma Chemical Surface Modification

(76) Inventors: Peter Doncheff Dineff, Sofia (BG); Lydia Georgieva Kostova, Sofia (BG)

Correspondence Address: NEXSEN PRUET, LLC, P.O. BOX 10648, GREENVILLE, SC, 29603, US

(21) Appl. No.: 11/815,184

(22) PCT Filed: Jun. 1, 2006
(86) PCT No.: PCT/BG06/00012

§ 371 Date: Jul. 31, 2007

(30) Foreign Application Priority Data
Jun. 14, 2005 (BG) 109189

(51) Int. Cl. H05H 1/42

(52) U.S. Cl. 427/569

(57) ABSTRACT

The invention relates to a method for plasma chemical surface modifying of materials and items, and specifically for plasma aided impregnation with solutions containing fire retardants to make porous materials. The subject matter of the invention is solved by the method of plasma chemical surface modification of porous materials and workpieces to provide fire spread and ignition resistance consisting in autoclave high pressure impregnation and further drying at room temperature, a characteristic of which is that before the impregnation the surface of the material or the workpiece is submitted to a treatment for a period of 3 to 300 seconds with cold non-equilibrium plasma of glow electrical discharge at atmospheric pressure that burns under voltage of 1 to 3 kV and at a frequency of 50 Hz to 100 kHz.

### FIELD OF THE INVENTION

The invention relates to a method for plasma chemical surface modifying of materials and items, and specifically for plasma aided impregnation with solutions containing fire retardants to make porous materials like textile, leather, wood, foamed polymers and items made of them resistant to fire and ignition, so it can be applied for fire protection of stage equipment in cinematography, theater and TV studios; the interior and furniture of houses, public and office buildings, large public halls, restaurants, discotheques, hotels; the interior of transport means like airplanes, ships, motor vehicles, trains.

### DESCRIPTION OF THE PRIOR ART

Methods and solutions based on organic and inorganic chemical compounds called fire retardants providing fire and ignition resistance of materials by impregnation under pressure in autoclave, by dipping, casting, spreading with application roll, brush or by spraying under pressure are known in the art.

Multiple traditionally used products containing fire retardants based on phosphoric and nitrogen compounds and used for impregnation of different workpieces can be mentioned, i.e. FIREX 4160 (based on organic and inorganic salts), FIREX WZA (based on modified ammonium polyphosphate solution) of the company ‘D. R. Th. Böhme’—Chem Fabrik GmbH & Co. & Geretsried (Germany); Sandoz FR 1030 (based on phosphonitrilchloride, di-brom-neopentyl glycol and acrylic latex) of Sandoz (Switzerland); Taion TPD V and Taion TPD-100 [based on tetraquis-(hydroximethyl)-phosphonic chloride (THPC), carbamide and melamine] of Toybo company (Japan), ‘Pyron 650P’ of the company ‘Chemonie Industries’ (USA), ‘Antiblaze’ of ‘Mobil’ (USA) etc.

(3, new)* The main demerits of these methods and solutions that give fire spread and ignition resistance to polymer, wood and textile porous materials and products are defined by their poor efficiency and reliability. Migration of fire retardant products is observed in conditions of vigorous changes of humidity, during the cleaning or washing process a fact that can lead to partial or full loss of the effect in further use. For example, after impregnation by spraying of wood objects a substantial migration outside and in-depth the micro porous structure is observed under conditions of vigorously changing humidity.

In-depth migration may be restricted with the methods known in the art, such as in-depth impregnation of materials under pressure in autoclave. Outside migration however remains and reduces less or more the reliability of the fire protection after a determined number of washing of carpets and textile, and, depending on the material and the solutions used, the materials may lose completely the quality they have been given.

Another demerit of the methods for providing fire spread and ignition resistance is defined by the limited applicability of the methods ‘on-site’ with the client, i.e. it is impossible to give a direct treatment of the already produced object (floor, curtains, carpet, fabric) on the place where it is used. For example, the ‘on site’ treatment with impregnation solutions of wooden floor, of the structure elements made of wood or of a woolen carpet already in use is only possible by spraying, which is the most universal of the impregnation methods used, but it is the less reliable with regards to product migration. While the most reliable impregnation method—by autoclave, is a technologically and technically complex and difficult to apply ‘on site’ method, more if large size objects are concerned.

A product based on phosphoric and nitrogen containing compounds is known in the art, according to BG P 33508 (1994) that on the basis of its good immobilization on the product or material surface allows a reliable and efficient application by dipping, casting or spraying at atmospheric pressure and room temperature, providing fire and ignition resistance to polymers, wood, leather and textile products.

The main shortcoming of the solution which composition is known in the art and is intended to provide fire spread resistance consists in the still inferior, although relatively high grade of immobilization of the product after the impregnation by spraying, casting or dipping. Solutions should be sought for chemical activation of the polymer, wood and textile surfaces processed so that after the impregnation of the materials the products that provide the fire resistance could be immobilized within the material volume or on its surface. This would strongly increase the efficiency and the reliability of the methods for product and material impregnation used.

A plasma chemical non-destructive method is known in the art for surface activation of polymer materials and products, such as foils, films and products, as woven and non-woven textile and melt blown textile, in glow discharge plasma (OAUGD plasma) at atmospheric pressure (in air, argon, helium) with the aim to change their surface condition: by displacement of their lyophillic-lyophobic equilibrium, changing the moisturizing of the material or product surface according to U.S. Pat. No. 5,403,453 (1995) and the related U.S. Pat. No. 5,456,972 (1995). This technology is not meant for impregnation of wood and wood materials.

The application of glow discharge at atmospheric pressure is protected and represents another kind of barrier discharge at near the atmospheric pressure (1 atm; 1.03 at; 760 mm MC or 760 Torr; 1.01.10⁵ Pa; 1.01 bar) that burns steadily between two plate electrodes mounted in face-to-face parallel alignment separated by a dielectric barrier forming a working gap between them where plasma field is created when 1 to 5 kV (real value) voltage of the radio frequency range of 1 to 100 kHz is applied on the plates.

Plasma acts directly on the processed surface with its UV-radiation and the chemically active particles of different composition generated in the plasma volume. Therefore the plasma chemical processing: cleaning, chemical activation or functionalization, etching and plating becomes an important feature of the low temperature (cold) atmospheric plasma technologies. Thus the demanding and expensive vacuum technologic system, characteristic for the plasma chemical technologies of low pressure glow discharge is discarded.

A method for surface plasma modifying of wooden objects is known in the art (EP 1 233 854 B1, 2004 or DE 199 577 775, 1999) comprising the following subsequent steps: an electrode plate is placed against the wooden surface to be modified; a dielectric layer or barrier is arranged between this electrode and the wooden surface to be modified; an alternating high voltage is applied on the electrode with a frequency of more than 600 Hz, as well as on the wooden object, the surface of which acts as the opposite electrode in order to provide a barrier discharge between the wooden surface and the electrode at atmospheric pressure.

This method for modifying of wood surfaces with electric discharge at atmospheric pressure allows the processing of large-size wooden objects, the processing being done successively surface by surface. The plasma chemical processing of the wooden surface (free or already coated with primer or varnish) is intended for cleaning the surface, bonding, and placement of varnish coatings, painting, bleaching, and protection. This technology is not meant for impregnation of wood and materials made of wood.

The major shortcoming of this method consists in the fact that objects that have no electrical conductivity (conductors, semiconductors) cannot be plasma treated, i.e. the method is applicable only to wood and wooden objects. Another demerit of this method is defined by the need to work with relatively high voltage and frequency (over 600 Hz) in order to achieve the barrier discharge at atmospheric pressure at a distance of 25 mm to the surface treated.

The main deficiency of the stated plasma chemical technologies for modifying and giving fire spread and ignition resistance of materials and products made of them consists in the fact that the impregnation has not been conformed with the results of the plasma surface activation, and mainly with the modified or acquired ion activity of the surface treated, a fact that substantially influences over the capillary activity of the material and therefore over the impregnation result. In these cases the plasma chemical activation of the surface and the impregnation that follows are not disclosed as an integrated technological process. Often it is necessary to look for a technology that provides substantial changes of determined quality indices of an already created item, and to allow its use at changed customer's requirements. In this case, the surface plasma modifying should be effectively provided at different geometry and size of the items that is a challenge for all technologies based on the use of electric discharge at atmospheric pressure. The high ion and electron concentration that is a very good technologic advantage of the Debye's radius at atmospheric pressure, and therefore the small space of the plasma field between the electrodes.

The main deficiency of the plasma chemical technologies described above consists in that it is impossible to process large in volume and size objects. The issue of ‘on site’ treatment is simply ignored because the maximum size of the working plasma field is up to 15 to 20 mm.

With the development of plasma applicators the formation of plasma layers is achieved by isolated electrodes placed over dielectric or isolated metal surface, consisting of separate strips of alternating polarity. The insulation laid on the alternating strips acts as a barrier. Thus the discharge glows between each two adjacent metal strips, separated by two dielectric traps, U.S. Pat. No. 5,938,854 (1999).

At the same time however remains the electrode that embraces the volume which is placed under the potential of one of the electrodes. Another preferred embodiment is also protected wherein the trap is embraced not only by the external electrode, but by a metal earth shield. The generator has a feeding winding divided in two with a central point connected to earth. The second electrode is fed symmetrically to the earth shield.

The plasma remains confined between the electrodes that create it. That is why these surface methods of plasma chemical activation require the complete ‘dipping’ of the workpiece treated in the plasma, which limits their application to the treatment of foils, laminates, woven and non-woven textile products, i.e. thin and plane workpieces up to 15 to 20 mm thick.

Diode applicators are known in the art, creating glow discharge flat (plane) plasma layer under atmospheric air pressure wherein both electrodes embrace firmly the dielectric trap, one of them consisting of separated strips (sectors).

The plasma layer (or coating) is formed in the gap between two adjacent strips, and depending on the width of the strips and the gaps between them; the plasma layer covers firmly the whole surface of the composite electrode. These are the first technical devices that give the plasma the possibility to get out of the electrode system that has created it. These plasma barrier layers however are not used for modifying the surface of materials, they are used in aviation and for the design of new kind of pump units, U.S. Pat. No. 6,200,539 (2001). The technologic devices of the company ‘Plasma Treat North America Inc.’ are known in the art. They are produced under the trademark of ‘Flume’ and are intended for plasma chemical treatment of surfaces by a flame-like jet of zero electric potential.

Another technological devices for plasma chemical treatment of surfaces are known in the art, intended for activating, cleaning, etching and layer plating through cold plasma jet system at atmospheric pressure. These are the plasma radio frequency (RF) technological systems of the kind ‘Atomflo’ and ‘Plasma Flow Systems’ of a power of 100 to 600 W, offered on the market by the company ‘Surfux Technologies’ (USA). They are manufactured with a round nozzle of Ø25 or Ø50 mm diameter. There is a version of rectangular nozzle of 25 mm width, too.

The company ‘Arcotec GmbH’ Germany is also a manufacturer of low temperature plasma technological devices ‘Arcojet’ and ‘Arcospot’ based on high frequency (HF) corona discharge.

The basic deficiency of these plasma technologies and technical devices consists in the small nozzle size and the flame-like plasma jet, which makes them applicable mainly on a small area and in small-size workpieces, restricting their application mainly in the field of electronic industry and microtechnologies.

When larger areas are treated, multiple devices are mounted in order to achieve the necessary width. It is referred to stationary industrial systems of relatively large capacity and high complexity. Despite the technological advantages of the cold plasma jet, technical devices of increased capacity for ‘on site’ surface treatment are not offered yet.

Taking into consideration the above-mentioned technical methods, the object matter of the invention is to create a method for plasma chemical modifying and specifically to provide fire spread and ignition resistance properties to polymer, leather, wooden and textile materials and workpieces. The method should allow a highly effective and reliable modification of the surface of the workpiece by impregnation with water solutions, containing fire retardants: organic and inorganic compounds of phosphorus and nitrogen by means of dipping, casting, spreading with roll, brush or by spraying at regular atmospheric pressure and room temperature.

The method should provide at maximum good spreading, impregnation and immobilization of the products (after drying), giving a stable increased fire spread and ignition resistance of the material or the workpiece.

The method for modifying the surface properties of plastic, leather, wood and textile workpieces should allow the ‘on site’ treatment of large-size workpieces or the so-called unilateral treatment of the workpiece surface by surface.

### SUMMARY OF THE INVENTION

The subject matter of the invention is solved by the method of plasma chemical surface modification of porous materials and workpieces, and, specifically, to provide fire spread and ignition resistance consisting in autoclave high pressure impregnation, impregnation by dipping, casting, spreading with roll or by spraying, under high or low pressure, of fire retardant water solutions based on nitrogen and phosphorus containing compounds at atmospheric pressure and room temperature and further drying at room temperature, a characteristic of which is that before the impregnation the surface of the material or the workpiece is submitted to a treatment for a period of 3 to 300 seconds with cold non-equilibrium plasma of glow electrical discharge at atmospheric pressure that burns under voltage of 1 to 3 kV and at a frequency of 50 Hz to 100 kHz.

According to a preferred embodiment of the method after surface plasma chemical treatment with cold non-equilibrium plasma at atmospheric pressure, and before the material is impregnated with the solution containing fire retardants, the treated surface shall remain freely in air at atmospheric pressure and room temperature for a lapse of 5 to 150 min depending on the nature of the material treated.

The water solutions used for impregnation contain phosphoric and nitrogen compounds, which makes it possible that one of the preferred embodiments of the method the surface to be activated in advance in glow discharge non-equilibrium air plasma.

According to a preferred embodiment of the method the surface plasma treatment is effected by placing an electrode against one of both treated surfaces of the workpiece; a dielectric layer or barrier is firmly placed over this electrode on the side of the treated surface; a second perforated electrode is placed between the face of the dielectric barrier and the treated surface of the workpiece; a third electrode is placed immediately over the second treated surface so that the workpiece treated acts as a second dielectric barrier (if the workpiece is dielectric), of a semiconductor barrier (if the workpiece is a semiconductor) or of part of the third electrode (if the workpiece is a conductor); an alternate high voltage is applied with frequency equal or higher than 50 Hz, the first of the electrodes being electrically connected to the ‘high tension’ pole of the power supply, the third electrode is electrically connected directly to the earthed pole of the power supply in a way that between the two electrodes, and precisely in the gaps on both sides of the workpiece treated: between the dielectric barrier and the first treated surface of the workpiece, and between the third electrode and the second treated surface of the workpiece is ignited and burns the main barrier electric discharge; the second electrode is connected electrically to the earth connected pole of the power supply through a reactive element: capacitor or reactor serially connected to the gap formed between the electrodes, providing phase displacement of the ignition and burning of auxiliary barrier electric discharge between the surface of the dielectric barrier and the perforated electrode; plasma sustaining gas is blown under pressure in the gaps formed between the electrodes, the barrier and the workpiece, so that the chemically active particles formed in the plasma could enter in contact with the surfaces treated.

According to a preferred embodiment of the method the second or the perforated electrode is placed immediately over the surface of the dielectric layer or barrier, reducing the size and simplifying the technology.

According to another preferred embodiment of the method if the workpiece is an electric conductor or semiconductor, for example, wood, the workpiece itself acts as third electrode, electrically connected directly to the earth connected pole of the power supply, allowing the unilateral treatment of the workpiece or the workpiece surface activation by processing the surfaces one after the other.

According to another preferred embodiment of the method the third electrode is perforated and placed between the second electrode and the workpiece treated surface at a distance of 25 to 30 mm from it, allowing the unilateral treatment of large-size workpieces and large surface areas.

According to another preferred embodiment of the method the first electrode and the dielectric barrier constitute a closed surface of prismatic or cylindrical shape along the axis on which the second plane or cylindrical electrode is attached; after the alternate high voltage is supplied to the electrodes, plasma sustaining gas is supplied from the gas distribution chamber to the working chamber formed which leads to the formation of direct application plasma jet system or the main dielectric barrier discharge glows between the barrier surface and the workpiece surface. Another version of this embodiment is developed wherein the workpiece that features high conductivity acts as third electrode.

According to another embodiment of the method the second and the third electrodes are placed into the working chamber enabling the accomplishment of a plasma jet system of indirect application. In this case the surface treated is not a part or is not within the electrode system. Plasma jet released out of the electrode system acts over this surface.

According to a preferred embodiment of the method the impregnation is effected with non-ionogen impregnating solution, containing more than 30 mass % dry substance (nitrogen and phopsphorated fire retardants or antipyrenes) with ion activity that changes proposefully just before the impregnation takes place by adding non-ionogen, anionogen and cationogen surfactants once verified the acquired (or increased) ion activity of the surface as a result of its plasma activation, i.e. the impregnation is accomplished with anion active impregnating solution if the surface activity has become cation exchange, or with cation exchange impregnating solution if the surface activity has become anionic, or with non-ionogen impregnating solution if both anion and cation exchange activity of the treated surface is observed allowing to accomplish a joint plasma aided impregnation process.

According to a preferred embodiment of this method the acquired (or increased) ion activity of the surface treated: anionic or cationic, is performed by evaluation of the diameter of a drop of the test solution in time on the surface studied, using ionogen dye test solutions, i.e. cation exchange 0.8 to 1.6 mass % water or ethanol solution of methylene blue (thiazine basic dye), and anion exchange 0.8 to 1.6 mass % water solution of methyl orange, allowing the accomplishment of maximum effective process of plasma aided impregnation by introducing more dry substance for a time unit in equal conditions through the treated surface of the workpiece.

The method of plasma chemical modifying described is distinguished for its improved technology, applicability, universality, reliability and quick action. It may be applied in the industry and ‘on site’ with the client no matter the size of the workpiece treated and the accessibility of the surfaces.

The method for surface modifying disclosed where plasma chemical treatment of the surfaces takes place in the plasma of barrier non-equilibrium discharge at room temperature and atmospheric pressure allows the manifestation of the positive qualities of the technologies for impregnation and spreading of protective solutions, containing nitrogen and phosphoric fire-retardants by dipping, casting, spraying or spreading with roll or brush.

Chemically active centers are formed on the protected surface as a result of its preliminary plasma chemical treatment establishing later during the impregnation chemical bonds providing the immobilization of the nitrogen and phosphor containing compounds spread over their surface or introduced in their volume. This treatment increases even more the capillary activity of the porous materials based on wood, leather, woven and non-woven textile, which on the other hand is a premise for increasing the fire protection efficiency and reliability.

The method for surface modification accomplished with plasma chemical processing of the surfaces in the plasma of dielectric barrier non-equilibrium discharge at a room temperature and atmospheric pressure enables the manifestation of the positive qualities of the impregnation and spreading technologies for application of protective solutions containing phosphoric and nitrogen fire retardants by dipping, casting, spraying or spreading with roll or brush.

### BRIEF DESCRIPTION OF THE DRAWINGS

A preferred embodiment of the method for plasma chemical modifying of the surfaces of porous workpieces made of wood, leather, polymers and textile before spreading the solutions by dipping, spraying or spreading with roll is illustrated with the figures attached to the description, wherein:

FIG. 1 is a schematic representation of the method of bilateral plasma chemical treatment of the workpiece, accomplished with triode closed plasma system, feeding the plasma gas (i.e. air) under pressure between the electrodes;

FIG. 2 is a schematic representation of an embodiment of the method of bilateral plasma chemical treatment of the workpiece, achieved with triode closed plasma system, of the electric supply to the electrode system, where the perforated second electrode is placed just over the surface of the dielectric layer or barrier;

FIG. 3 is a schematic representation of the method of one side plasma chemical treatment of a workpiece, achieved with triode closed plasma system, where the workpiece acts as a third electrode;

FIG. 4 gives a schematic representation of the method of one side plasma chemical treatment of a workpiece, achieved with triode open plasma system, where the third electrode is placed between the second electrode and the treated surface of the workpiece;

FIG. 5 is a schematic representation of the method of double sided plasma chemical treatment of the workpiece accomplished with triode closed direct plasma jet system, the main barrier discharge glowing between the surface of the dielectric barrier and the facing treated surface of the workpiece, and between the second treated surface and the third electrode.

FIG. 6 gives a schematic representation of the method of one side plasma chemical treatment of the workpiece accomplished by triode open plasma system, where the workpiece itself acts as third electrode.

FIG. 7 gives a schematic illustration of the technology of one side plasma chemical treatment of the workpiece accomplished with triode open plasma system, where the second and the third electrodes are placed inside the working chamber.

### DESCRIPTION OF THE PREFERRED EMBODIMENT

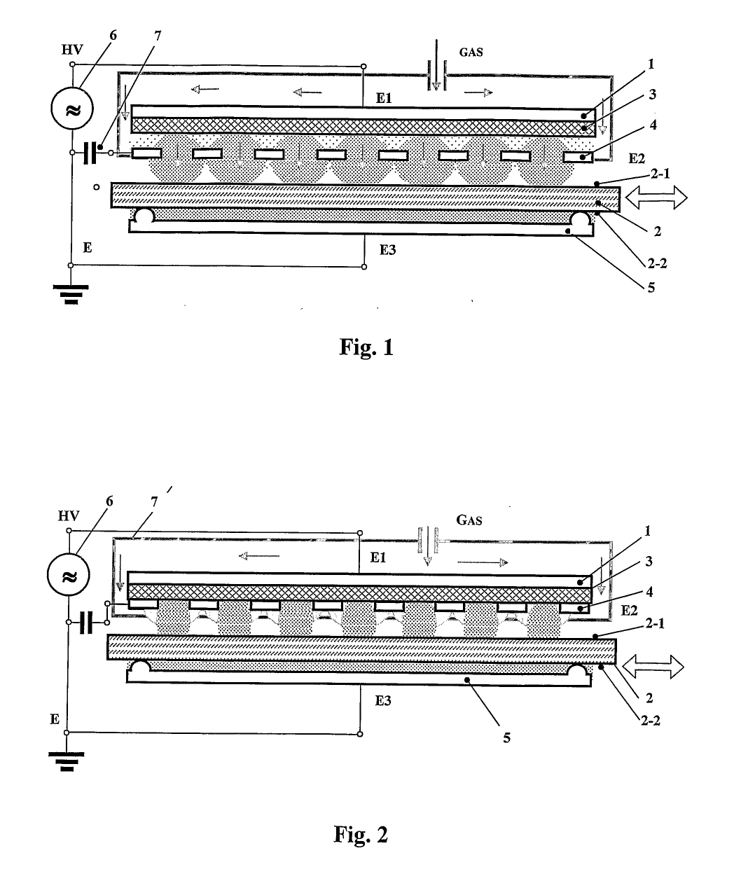

According to the technological scheme illustrated on FIG. 1, the plasma treatment of the surface is effected by placing the electrode plate 1 in parallel arrangement against one of both surfaces treated 2-1 of the workpiece 2, placing a dielectric layer of barrier 3 firmly over the electrode 1 on the side of the surface treated 2-1; placing a second perforated electrode 4 between the surface of the dielectric barrier 3 and the surface treated 2-1, and directly over the second surface treated 2-2 is placed a third electrode plate 5. The workpiece 2 treated acts as second dielectric barrier (if the workpiece is dielectric), of semiconductor barrier (if the workpiece is semiconductor) or as part of the third electrode (if the workpiece is a conductor).

Alternate high voltage with a frequency of 50 Hz (or higher) is applied to the electrodes 1, 4 and 5, connecting electrode 1 electrically to the high voltage pole of the power supply 6, electrode 5 is electrically connected directly to the earthed pole of the high voltage power supply 6 so that between the two electrodes 1 and 5, and specifically in the air gaps on both sides of the workpiece 2—between the dielectric barrier 3 and the surface 2-1 treated, and between the electrode 5 and the surface 2-2 treated ignites and burns the main dielectric barrier discharge.

The electrode 4 is electrically connected to the earth connected pole of the source 6 through the reactive element 7—capacitor or reactor in series connection that provides phase displacement of the ignition and burning of a second auxiliary barrier electrical discharge between the surface of the dielectric barrier 3 and the perforated electrode 4.

Plasma sustaining gas (air) is blown under pressure in the gaps formed between the electrodes 1, 4 and 5, the barrier 3 and the workpiece 2, so that the chemically active particles formed in the plasma could enter in contact with the surfaces treated 2-1 and 2-2.

As the workpiece 2 moves, both surfaces 2-1 and 2-2 are uniformly treated by the plasma of the simultaneously glowing two electrical discharges. The ignition and the glowing of the discharges is mutually related and that enables them glow at lower voltage and at working gap between the electrode 4 and the surface 2-1 treated of about 25 mm—about 8 to 9 kV against 12-13 kV (at 50 Hz). At a frequency of 30 kHz this voltage is even lower—about 6 to 7 kV.

According to the technologic scheme given on FIG. 2, the plasma treatment of the surfaces 2-1 and 2-2 of the workpiece 2 is performed by direct arrangement of the perforated electrode 4 over the surface of the dielectric barrier 3.

According to the technologic scheme presented on FIG. 3, the plasma treatment of the surface 2-1 is achieved by an arrangement in which the workpiece 2 itself, being a conductor or semiconductor, acts as the electrode 5. The workpiece is connected electrically to the earth pole of the source 6 through the contact rolls 8.

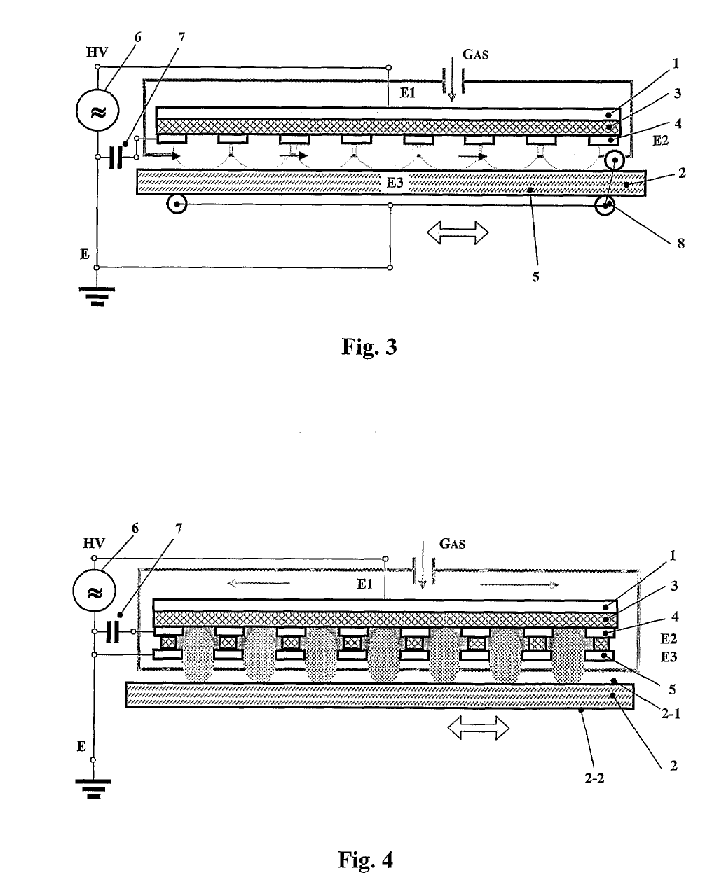

According to the technological scheme presented on FIG. 4, the plasma treatment of the surface 2-1 is effected displacing the electrode 5 and arranging it between the electrode 4 and the plasma treated surface 2-1. Thus the plasma applicator is arranged out of the workpiece 2 treated and allows the successive treatment of its surfaces one after the other while it is displaced against the applicator.

The supply of plasma sustaining gas under pressure within the volume of the barrier discharge enables the migration of the chemically active particles out of the plasma volume and allows them establish a chemically active contact with the surface 2-1 treated. The UV radiation of the discharge acts directly over the surface 2-1 treated.

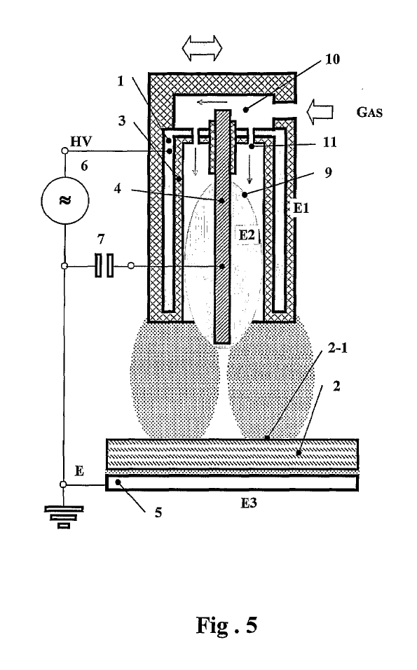

According to the technological scheme given on FIG. 5, the plasma treatment of the workpiece 2 surfaces 2-1 and 2-2 is achieved as the electrode 1 and the dielectric barrier 3 constitute a closed surface of prismatic or cylindrical shape facing the surface 2-1. Along the axis of the confined space is placed the second electrode 4 of plane or cylindrical shape. The plate electrode 5 remains at a distance parallel to the surface 2-2 treated. Electrode 1 is connected electrically to the ‘high voltage’ pole of the high voltage power supply 6. The electrode 4 is connected to the earth pole of the source through the reactive element 7—capacitor or reactor, that provides a phase displacement of the ignition and burning of the auxiliary barrier electrical discharge between the surface of the dielectric barrier 3 and the electrode 4. The electrode 5 is connected directly to the earth pole of the feeding source 6. After an alternate high voltage is supplied to the electrodes 1, 4 and 5 plasma sustaining gas (air) under pressure is supplied from the distribution gas chamber 10 to the working chamber 9 formed, igniting both barrier discharges that glow in air at atmospheric pressure.

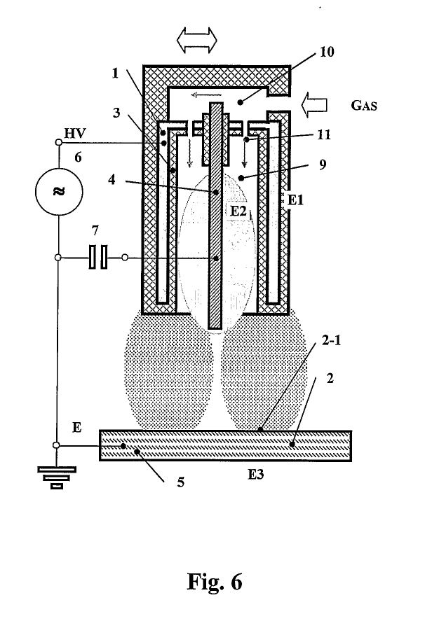

According to the technologic scheme given on FIG. 6, the plasma treatment of the surface 2-1 of the workpiece 2 is achieved by connecting the conductor or semiconductor workpiece 2 directly and electrically to the earth pole of the high voltage power supply 6, i.e. the workpiece 2 acts as the electrode 5.

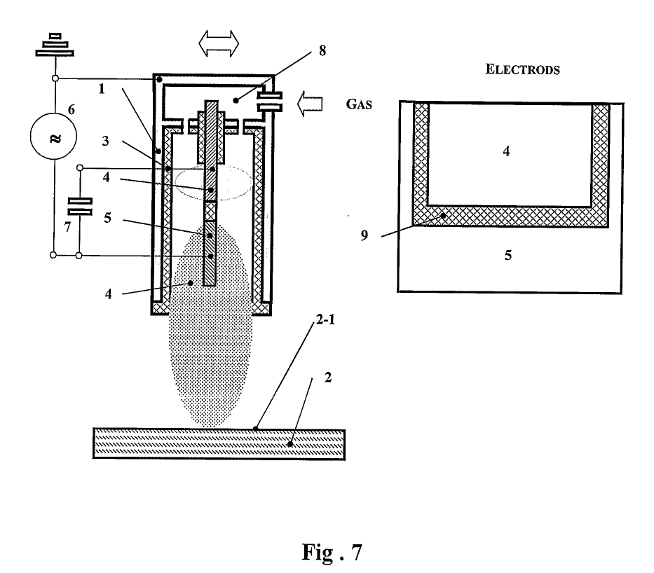

According to the technological scheme given on FIG. 7, the plasma treatment of the surface 2-1 of the workpiece 2 is achieved by placing the electrodes 4 and 5 into the working chamber 9. For security reasons the electric supply to electrodes 1, 4 and 5 is changes this way: electrode 1 that is also a casing is connected directly to the earth pole of the high voltage power supply 6, the electrode 4 is connected for galvanic purposes with the high voltage pole of the high voltage power supply 6 through the reactive element 7, and the electrode 5 is connected directly to the high voltage pole of the power supply 6.

The method of plasma chemical surface modification of polymer, wood and textile workpieces and materials, and especially to provide the characteristic of tough burning is illustrated in the examples given hereunder.

### EXAMPLE 1

Samples of pine wood without knots are treated according to the method, the surfaces of the samples being first plasma chemically treated in air plasma of glow discharge at atmospheric pressure that burns at a voltage of 6 to 10 kV and frequency 6 to 10 kHz.

After a 15 second cold plasma treatment the samples remain free at open air for about 25 minutes, and then a water solution of a determined composition according to table 1 is sprayed over at high pressure.

TABLE 1

| | Kind | |
|---|---|---|
| | of the | |
| | material | Results. Assay method |
| Composition of the solution | treated | according to BDS 16359/86 |
| Composition 1 | Pine wood | Average mass loss: 6.8% |
| HSI96 according to BG 33508 | | Tough burning |
| (1994) | | Fire spread and |
| | | ignition resistible |
| Composition 1 and preliminary | Pine wood | Average mass loss: 4.5% |
| plasma chemical treatment of the | | Tough burning |
| sample surfaces with glow | | |
| discharge at 10 kV (RMS) and a | | |
| frequency of about 10 kHz | | |
| Firex WZA | Pine wood | Average mass loss: 18% |

### Then the samples are let to dry at room temperature and normal pressure.

Control samples are prepared only by spraying the same composition, denominated as Composition 1 (HSI96) and with the commercial fire retardant solution Firex WZA.

All assays have been made according to the standard BDS 16359/86 at equal conditions. The results are given in Table 1.

### EXAMPLE 2

Textile samples of cotton/polyester (70/30) are treated according to the method, submitting the samples first to a plasma chemical treatment in the air plasma of a glow discharge at atmospheric pressure, that burns at a voltage of 6 to 10 kV and frequency of 6 to 10 kHz. After they are treated for a lapse of 15 seconds, the samples are left at open air for a period of about 25 minutes, and after that by spraying at high pressure they are covered with water solution of a determined composition. See Table 2.

Then the samples are left to dry at room temperature and normal atmospheric pressure.

Control samples are prepared only by spraying the same composition, denominated as Composition 2 (HSI96) and with the commercial fire retardant solution Firex 4160.

(34, new) * All assays have been made according to the standard BDS EN ISO 6941 at equal conditions. The results are given in Table 2.

TABLE 2

| | Kind of the material | Results. Assay method |
|---|---|---|
| Composition of the solution | treated | according to BDS 16359/86 |
| Composition 2 | Cotton/polyester 70/30 | There is no independent fire |
| HSI96 according to BG 33508 (1994) | | burning after the flame of the |
| | | burner is removed. No burning |
| | | pieces are falling or detached. |
| | | Class 1 - tough burning material |
| Composition 2 and preliminary plasma | Cotton/polyester 70/30 | There is no independent fire |
| chemical treatment of the sample | | burning after the flame of the |
| surfaces with glow discharge at 10 kV | | burner is removed. No burning |
| (RMS) and a frequency of about 10 kHz | | pieces are falling or detached. |
| | | Class 1 - tough burning material |
| Firex 4160 | Cotton/polyester 70/30 | There is no independent fire |
| | | burning after the flame of the |
| | | burner is removed. No burning |
| | | pieces are falling or detached. |

### EXAMPLE 3

Samples of pine wood without knots are treated according to the method, the surfaces of the samples being first plasma chemically treated for a lapse of 5 seconds in air plasma of glow discharge at atmospheric pressure that burns at a voltage of 6 to 10 kV and frequency 6 to 10 kHz.

After a the treatment the samples remain free at open air for about 15 minutes, and tests are held to verify the ion activity of the plasma treated surface and the control surface with 1.6 mass % water solution of cation active dye methylene blue and 1.6 mass % water solution of the anion active dye methyl orange.

The test shows not only a strong cationic activity, but also anionic activity of the untreated surface. After plasma treatment at atmospheric pressure the cationic activity has increased, while the anionic one has changed a little.

TABLE 3
Results of drop test for capillary activity: drop volume
15 μl (15 10⁻³ cm³)
Dimensions of the drop transversally and longitudinally
to the wood in mm

| | Samples | | | |
|---|---|---|---|---|
| | | | Plasma | |
| | Control sample | | modified sample | |
| Size after | 5 sec | 60 sec | 5 sec | 60 sec |
| Solution A: clean HSI 96 | 3/4 | 3/4 | 4/4 | 4/6 |
| Solution B: anion active HIS 96 | 10/11 | 12/18 | 8/14 | 14/25 |
| Solution B: cation active HSI 96 | 5/5 | 6/7 | 4/8 | 5/11 |
| Solution B: ion inactive HIS 96 | 4/6 | 4/12 | 6/15 | 7/23 |
| solution with surfactants | | | | |

This information makes it possible to produce four solutions for impregnation based on the nitrogen and phosphorus containing ion inactive solution commercially known as HIS-96, produced according to BG 33508 (1994): solution A is the unchanged impregnating solution HIS-96; solution B is the impregnating solution HIS-96 with anionogen surfactant added at weight ratio of 9:1; solution C is the impregnating solution HIS 96 with a cationogen surfactant added at weight ratio of 9:1; solution D is the impregnating solution HIS-96 with a non ionogen surfactant added at weight ratio of 9:1.

The results of the modified surface and ion activity of the impregnating solution are given on table 3.

The capillary activity of the wood surface increases mostly when anionogen surfactants are added to the basic ion inactive solution HIS-96, or the use of the increased cation activity of the surface may successfully be used for activating its capillary activity and the impregnation process.

### EXAMPLE 4

Samples of cotton textile (Denim) are treated according to the method, by first processing the samples following the plasma chemical treatment for 5 seconds in air plasma of glow discharge at atmospheric pressure that burns at a voltage of 6 to 10 kV and frequency of 6 to 10 kHz. The samples are left at open air for about 15 minutes after they are treated in plasma. Control samples are also prepared and they are not submitted to plasma treatment.

The control samples show high cationic activity, i.e. the sample solution on the basis of methylene blue is difficult to absorb through the capillaries of the fabric: the water is distributed, but the dye remains in the center of the drop. The anion activity test however is positive.

With regards to the abovementioned the four solutions of Example 1 for determining the capillary activity of the cotton fabric are used. The results are given on Table 4.

TABLE 4
Results of drop test for capillary activity: drop volume
15 μl (15 10⁻³ cm³)
Dimensions of the drop transversally and longitudinally
to the wood in mm

| | Samples | | | |
|---|---|---|---|---|
| | | | Plasma | |
| | Control sample | | modified sample | |
| Size after | 5 sec | 60 sec | 5 sec | 60 sec |
| Solution A: clean HSI 96 | 6/6 | 7/9 | 9/9 | 4/6 |
| Solution B: anion active HIS 96 | 9/9 | 10/10 | 11/11 | 12/14 |
| Solution B: cation active HSI 96 | 8/8 | 10/11 | 9/9 | 11/12 |
| Solution B: ion inactive HIS 96 | 6/7 | 10/11 | 9/10 | 11/14 |
| solution with surfactants | | | | |

The results given on Table 4 show that after the plasma treatment the cationic activity has increased and this is also confirmed by the results with solution B.

1. A method of plasma chemical surface modification of porous materials and workpieces to provide fire spread and ignition resistance, consisting in autoclave high pressure impregnation, impregnation by dipping at atmospheric pressure, impregnation by casting, impregnation by spreading with brush or roll, or impregnation by spraying, under high or low pressure of a solution, containing phosphoric and nitrogen compounds as fire retardants, and further drying at room temperature, characterized by that before the impregnation with the solution containing fire retardants, the surface is treated for a lapse of 3 to 300 seconds with cold non-equilibrium plasma of dielectric barrier (glow) discharge that burn at atmospheric pressure under voltage of 1 to 3 kV and at a frequency of 50 Hz to 100 kHz.

2. A method for plasma chemical surface modification according to claim 1, characterized by that after the plasma chemical treatment of the surface with cold non-equilibrium plasma at atmospheric pressure, before the material is impregnated with the solution containing fire retardants, the surface treated is left freely in air medium at atmospheric pressure and room temperature for a lapse of 5 to 150 minutes.

3. A method for plasma chemical surface modification according to claim 1, characterized by that the cold non equilibrium plasma is an air plasma.

4. A method for plasma chemical surface modification according to claim 1, characterized by that the surface plasma treatment is effected by placing an electrode against one of both treated surfaces of the workpiece; a dielectric layer or barrier is firmly placed over this electrode on the side of the treated surface; a second perforated electrode is placed between the face of the dielectric barrier and the treated surface of the workpiece; a third electrode is placed immediately over the second treated surface so that the workpiece treated acts as a second dielectric barrier (if the workpiece is dielectric), of a semiconductor barrier (if the workpiece is a semi conductor) or of part of the third electrode (if the workpiece is a conductor); an alternate high voltage is applied, the first of the electrodes being electrically connected to the ‘high voltage’ pole of the high voltage power supply, the third electrode is electrically connected directly to the earthed pole of the power supply in a way that between the two electrodes, and precisely in the gaps on both sides of the workpiece treated: between the dielectric barrier and the first treated surface of the workpiece, and between the third electrode and the second treated surface of the workpiece is ignited and burns the main barrier electric discharge; the second electrode is connected electrically to the earth connected pole of the power supply through a reactive element: capacitor or reactor, serially connected to the gap formed between the electrodes, providing phase displacement of the ignition and burning of auxiliary barrier electric discharge between the surface of the dielectric barrier and the perforated electrode; plasma sustaining gas being blown under pressure in the gaps formed between the electrodes, the barrier and the workpiece, so that the chemically active particles formed in the plasma could enter in contact with the surfaces treated.

5. A method for plasma chemical surface modification according to claim 4, characterized by that the second or the perforated electrode is placed directly over the surface of the dielectric layer or barrier.

6. A method for plasma chemical surface modification according to claim 4, characterized by that if the workpiece is an electric conductor or semiconductor, the workpiece itself acts as third electrode, electrically connected directly to the earth pole of the high voltage power supply, allowing the unilateral treatment of the workpiece or the workpiece surface activation by processing the surfaces one after the other.

7. A method for plasma chemical surface modification according to claim 4, characterized by that the third electrode is perforated and placed between the second electrode and the workpiece treated surface at a distance of 25 to 30 mm from it.

8. A method for plasma chemical surface modification according to claim 4, characterized by that the first electrode and the dielectric barrier constitute a closed surface of prismatic or cylindrical shape along the axis on which the second plane or cylindrical electrode is attached; after an alternate high voltage is supplied to the electrodes, plasma sustained gas is supplied from a gas distribution chamber to the working chamber formed.

9. A method for plasma chemical surface modification according to claim 8, characterized by that the workpiece acts as a third electrode.

10. A method for plasma chemical surface modification according to claim 8, characterized by that the second and third electrodes are placed inside the working chamber.

11. A method for plasma chemical surface modification according to claim 1, characterized by that the impregnation is effected with non-ionogen impregnating solution, containing more than 30 mass % dry substance (nitrogen and phopsphorated fire retardants or antipyrenes) with ion activity that changes proposefully just before the impregnation takes place by adding non-ionogen, anionogen and cationogen surfactants once verified the acquired (or increased) ion activity of the surface as a result of its plasma activation, i.e. the impregnation is accomplished with anion active impregnating solution if the surface activity has become cation exchange, or with cation exchange impregnating solution if the surface activity has become anionic, or with non-ionogen impregnating solution if both anion and cation exchange activity of the treated surface is observed.

12. A method for plasma chemical surface modification according to claim 1, characterized by that the verification of the acquired (or increased) ion activity of the surface treated: anion or cation exchange, is performed by evaluation of the diameter change of a drop of the test solution in time on the surface studied, using ionogen dye test solutions, i.e. cation exchange 0.8 to 1.6 mass % water or ethanol solution of methylene blue (thiazine basic dye), and anion exchange 0.8 to 1.6 mass % water solution of methyl orange.
